(19) United States
(12) Patent Application Publication
(10) Pub. No.: US 2012/0322393 A1
(43) Pub. Date: Dec. 20, 2012

(54) MULTIBAND LOOP ANTENNA AND PORTABLE RADIO COMMUNICATION DEVICE COMPRISING SUCH AN ANTENNA

(76) Inventors: Peter Lindberg, Uppsala (SE); Stefan Irmscher, Taby (SE); Andrei Kaikkonen, Jarfalla (SE)

(21) Appl. No.: 13/598,020

(22) Filed: Aug. 29, 2012

Related U.S. Application Data
(63) Continuation of application No. PCT/EP2010/053306, filed on Mar. 15, 2010.

(51) Int. Cl. H01Q 7/00; H04W 4/00

(52) U.S. Cl. 455/77; 343/722

(57) ABSTRACT

An exemplary embodiment of an antenna device for operation in at least two operational frequency bands generally includes a loop element having a feeding end for connection to radio communication circuitry and a grounding end for connection to ground. The antenna device also includes first filtering means connecting the grounding end to ground, and switching means parallel with the first filtering means. The switching means is configured to connect the grounding end to ground parallel with the first filtering means in a first state, to match the loop element to a first operational frequency band of the at least two operational frequency bands. The switching means is configured to connect the grounding end to an open end parallel with the first filtering means in a second state, to match the loop element to a second operational frequency band of the at least two operational frequency bands.

### CROSS-REFERENCE TO RELATED APPLICATION

This application is a continuation of PCT International Patent Application No. PCT/EP2010/053306 filed Mar. 15, 2010, published as WO2011/113472. The entire disclosure of the above application is incorporated herein by reference.

### FIELD

The present disclosure relates generally to antenna devices for use in portable radio communication devices, such as mobile phones.

### BACKGROUND

This section provides background information related to the present disclosure which is not necessarily prior art.

Internal antennas have been used for some time in portable radio communication devices. There are a number of advantages connected with using internal antennas, of which can be mentioned that they are small and light, making them suitable for applications wherein size and weight are of importance, such as in mobile phones.

One type of frequently used antenna in this regard is the Planar Inverted F Antenna (PIFA), which generally uses the whole device as a radiator. This antenna functions well and provides good multi-band functionality.

But there may be a problem when a portable radio communication device or terminal having this type of antenna is used by a person having hearing aid equipment. There might be interference in this hearing aid equipment caused by such an antenna. Therefore, there exists a so-called Hearing Aid Compatibility (HAC) requirement in some countries. This complicates the use of the PIFA antenna. In order to fulfill the HAC requirement, research has been made into alternative antennas.

One antenna type that is promising is the loop antenna. One reason for this is that the loop antenna, at some frequencies, does not use the whole terminal as a radiator. Therefore, it is possible to place the antenna far from the end of the terminal intended to face a hearing aid and thereby obtain interference reduction.

But there is a problem with this type of antenna and that is the bandwidth covered. Today's antennas for use in cellular communication, like Long Term Evolution (LTE), are to cover a number of wide frequency bands, where a first band is around 700 megahertz (MHz) and a second band is between 1710 and 2170 MHz. The loop antenna has problems in being able to cover the very wide second band. There is thus a need for providing a loop antenna that has a better wide band capacity, for instance when covering a first lower band of medium width together with a second higher band of higher width.

### SUMMARY

This section provides a general summary of the disclosure, and is not a comprehensive disclosure of its full scope or all of its features.

According to various aspects, exemplary embodiments are disclosed of antenna devices. In an exemplary embodiment, there is provided an antenna device for operation in at least two operational frequency bands. The antenna device generally includes a loop element having a feeding end for connection to radio communication circuitry and a grounding end for connection to ground. The antenna device also includes first filtering means connecting the grounding end to ground, and switching means parallel with the first filtering means. The switching means is configured to connect the grounding end to ground parallel with the first filtering means in a first state, to match the loop element to a first operational frequency band of the at least two operational frequency bands. The switching means is configured to connect the grounding end to an open end parallel with the first filtering means in a second state, to match the loop element to a second operational frequency band of the at least two operational frequency bands.

Another exemplary embodiment provides a portable radio communication device comprising an antenna device for operation in at least two operational frequency bands. The antenna device generally includes a loop element having a feeding end for connection to radio communication circuitry and a grounding end for connection to ground. The antenna device also includes first filtering means connecting the grounding end to ground, and switching means parallel with the first filtering means. The switching means is configured to connect the grounding end to ground parallel with the first filtering means in a first state, to match the loop element to a first operational frequency band of the at least two operational frequency bands. The switching means is configured to connect the grounding end to an open end parallel with the first filtering means in a second state, to match the loop element to a second operational frequency band of the at least two operational frequency bands. The antenna device further includes second filtering means between the ground and the first state of the switching means, and DC blocking means arranged on the input and outputs of the switching means.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an antenna device having a series-switched loop radiator.

FIG. 2 illustrates an antenna device according to a first exemplary embodiment.

### DETAILED DESCRIPTION

Example embodiments will now be described more fully with reference to the accompanying drawings.

Exemplary embodiments are disclosed of antenna devices and portable radio communication devices including such antenna devices. In an exemplary embodiment, there is an antenna device for a portable radio communication device, which provides good frequency band coverage based on a loop element.

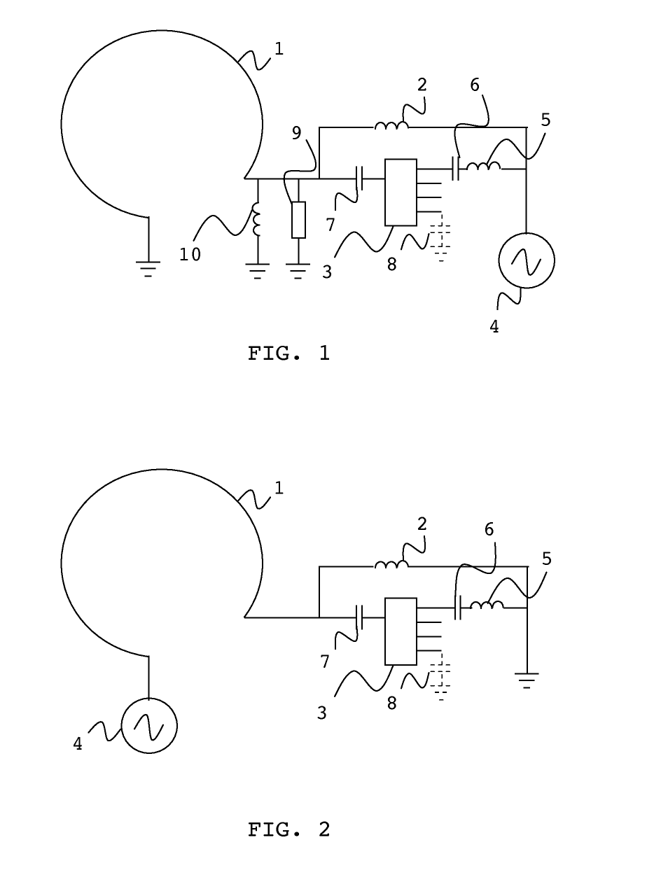

A way of realizing multiple frequency band coverage of an antenna device is to use a series-switched loop radiator, as illustrated in FIG. 1. Such an antenna device comprises a loop element 1 having a grounding end and a feeding end.

The grounding end is connected to ground. The feeding end is connected to radio communication circuitry 4 through a series inductor 2, typically called a bypass inductor. The feeding end also comprises a shunt inductor 10 as well as electrostatic discharge (ESD) protection 9 arranged parallel with the shunt inductor 10. Further, switching means 3 is arranged parallel with the series inductor 2, to provide multiple matching of the loop element 1. The switching means 3 is configured to have a first state in which the switching means 3 connects the feeding end to the radio communication circuitry 4 through a series inductor 5, and a second state in which the switching means 3 connects the feeding end to an open end. The open end of the switching means 3 will intrinsically have a parasitic capacitance 8 coupling the feed point to ground. Both the input and outputs of the switching means are preferably provided with DC blocking capacitors 6 and 7.

But this solution has some drawbacks. For example, the parasitic capacitance 8 short-circuits the antenna device for high frequencies, typically from about 2 gigahertz (GHz). To reduce this influence, the shunt inductor 10 is provided, making the bypass inductor 2 large and creating a large voltage swing over the switching means at low frequencies, for e.g. a desired 700 megahertz (MHz). The large voltage swing over the switching means 3 will generate harmonics due to non-linearity in the switching means 3 and will also, in turn, require ESD protection at the feeding end.

Aspects of the present disclosure are based on the realization that by moving the switching means from the feed end of the loop element to the ground end thereof the drawbacks mentioned above are mitigated and 1-2 components can be removed.

In an exemplary embodiment, there is provided an antenna device for operation in at least two operational frequency bands. The antenna device includes a loop element having a feeding end for connection to radio communication circuitry and a grounding end for connection to ground. The antenna device also includes first filtering means connecting the grounding end to ground and switching means provided parallel with the first filtering means. The switching means is configured to have a first state and a second state. In the first state, the switching means connects the grounding end to ground parallel with the first filtering means to match the loop element to a first operational frequency band of the at least two operational frequency bands. And in the second state, the switching means connects the grounding end to an open end parallel with the first filtering means to match the loop element to a second operational frequency band of the at least two operational frequency bands. This removes the need of a component for the antenna device, i.e., the shunt inductor, and generally another component for the antenna device, i.e., ESD protection.

For additional matching of the loop element, the antenna device preferably comprises second filtering means provided between the ground and the first state of the switching means. The first and second filtering means preferably each comprises a series inductor for simple matching. For further alternative matching of the loop element, the antenna device preferably comprises fourth filtering means connecting a third state of the switching means to ground, to provide matching to a third frequency band.

FIG. 2 illustrates an first exemplary embodiment of an antenna device for operation in at least two operational frequency bands in a portable radio communication device. As shown, the antenna device comprises a loop element 1 having a feeding end and a grounding end. The feeding end is connected to radio communication circuitry 4. The grounding end is connected to ground through first filtering means 2, which is operable or acting as a bypass filter for switching means 3.

The switching means 3 is parallel with the first filtering means 2. The switching means 3 is configured to have at least a first state and a second state. In the first state, the switching means 3 connects the grounding end of the loop element 1 to ground parallel with the first filtering means 2 to match the loop element 1 to a first operational frequency band of the at least two operational frequency bands. But when the switching means 3 is in the second state, the switching means 3 connects the grounding end of the loop element 1 to an open end parallel with the first filtering means 2 to match the loop element 1 to a second operational frequency band of the at least two operational frequency bands.

The antenna device intrinsically comprises a parasitic capacitance 8 parasitically connecting the second open state of the switching means 3 to ground. A typical parasitic capacitance is in the order of 0.5-2 picofarads (pF).

The antenna device preferably comprises second filtering means 5 provided between ground and the first state of the switching means 3. Further, the antenna device preferably comprises DC blocking means 6 and 7 arranged on the input and outputs of the switching means 3, preferably realized as series capacitors of about 100 pF.

For configuration of an antenna device to provide operation in the LTE operational frequency band 700 and the cellular operational frequency bands 850, 1800, 1900 and 2100, the following component values are e.g. used. The loop element 1 has an electrical length corresponding to λ for 1850 MHz. The first filtering means 2 comprises a series inductor of about 13 nanohenries (nH). The second filtering means 5 comprises a series inductor of about 0 nH. The switching means 3 is a SP4T switch with one input and four outputs, one output for each of four states of the switch. In the first state of the switching means 3, frequency band coverage of cellular operational frequency bands 850, 1800, 1900 and 2100 are thus provided. And, in the second state of the switching means 3, frequency band coverage of the LTE 700 is thus provided.

For improved antenna efficiency, further switching states of the switching means 3 is preferably provided. The antenna device, in such a case, comprises fourth filtering means provided between ground and a third state of the switching means, for matching of the loop element 1 to a third frequency band. In the third state, the switching means 3 is configured to connect the grounding end of the loop element 1 to ground parallel with the first filtering means 2 to match the loop element 1 to a third operational frequency band. The fourth filtering means preferably comprises a series capacitor of about 2.7 pF. In the third state of the switching means, frequency band coverage of cellular operational frequency bands 900, 1800, 1900 and 2100 are thus provided.

Although series inductors have been described as realization means for matching of the loop element, series (or grounded parallel) capacitors could alternatively be used. An important advantage of series-switching the grounding end of the loop element, as compared to series-switching the feeding end of the loop element, is that the impact of the parasitic capacitance 8 is reduced thereby mitigating the impact on high frequency bands. This, in turn, removes the need for a shunt inductor at the loop element, in turn reducing the bypass inductor value. This also entails a significantly improved ESD protection, generally removing the need of additional ESD protection at the loop element.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. An antenna device for operation in at least two operational frequency bands, the antenna device comprising:
a loop element having a feeding end for connection to radio communication circuitry and a grounding end for connection to ground;
first filtering means connecting the grounding end to ground; and
switching means parallel with the first filtering means, wherein the switching means is configured to:
in a first state, connect the grounding end to ground parallel with the first filtering means to match the loop element to a first operational frequency band of the at least two operational frequency bands; and
in a second state, connect the grounding end to an open end parallel with the first filtering means to match the loop element to a second operational frequency band of the at least two operational frequency bands.

2. The antenna device of claim 1, wherein the first filtering means comprises a series inductor.

3. The antenna device of claim 1, further comprising second filtering means between the ground and the first state of the switching means.

4. The antenna device of claim 3, wherein the second filtering means comprises a series inductor to match the loop element to the first operational frequency band.

5. The antenna device of claim 3, wherein the second filtering means comprises a series capacitor for DC blocking.

6. The antenna device of claim 1, further comprising third filtering means between the switching means and the grounding end.

7. The antenna device of claim 6, wherein the third filtering means comprises a series capacitor for DC blocking.

8. The antenna device of claim 1, further comprising a parasitic capacitance parasitically connecting the second state of the switching means to ground.

9. The antenna device of claim 1, further comprising fourth filtering means connecting a third state of the switching means to ground, to match the loop element to a third frequency band.

10. The antenna device of claim 9, wherein the fourth filtering means comprises a series inductor.

11. The antenna device of claim 1, further comprising:
second filtering means between the ground and the first state of the switching means;
third filtering means between the switching means and the grounding end;
fourth filtering means connecting a third state of the switching means to ground, to match the loop element to a third frequency band; and
a parasitic capacitance parasitically connecting the second state of the switching means to ground.

12. The antenna device of claim 11, wherein:
the second filtering means comprises a series inductor to match the loop element to the first operational frequency band; and/or
the third filtering means comprises a series capacitor for DC blocking.

13. The antenna device of claim 11, wherein:
the parasitic capacitance is about 0.5 to 2 picofarads (pF); and/or
the loop element has an electrical length corresponding to λ for 1850 MHz; and/or
the first filtering means comprises a series inductor of about 13 nanoHenries (nH); and/or
the second filtering means comprises a series inductor of about 0 nH; and/or
the fourth filtering means comprises a series capacitor of about 2.7 pF; and/or
the switching means comprises a SP4T switch having one input and four outputs, one output for each of four states of the switch.

14. The antenna device of claim 1, further comprising DC blocking means arranged on the input and outputs of the switching means.

15. The antenna device of claim 14, wherein the DC blocking means comprise series capacitors of about 100 pF.

16. The antenna device of claim 1, wherein the antenna device is configured such that:
in the first state of the switching means, frequency band coverage of cellular operational frequency bands 850, 1800, 1900; and 2100 is provided; and
in the second state of the switching means, frequency band coverage of the LTE 700 is provided.

17. A portable radio communication device comprising the antenna device of claim 1.

18. A portable radio communication device comprising an antenna device for operation in at least two operational frequency bands, the antenna device comprising:
a loop element having a feeding end for connection to radio communication circuitry and a grounding end for connection to ground;
first filtering means connecting the grounding end to ground;
switching means parallel with the first filtering means, wherein the switching means is configured to:
in a first state, connect the grounding end to ground parallel with the first filtering means to match the loop element to a first operational frequency band of the at least two operational frequency bands; and
in a second state, connect the grounding end to an open end parallel with the first filtering means to match the loop element to a second operational frequency band of the at least two operational frequency bands;
second filtering means between the ground and the first state of the switching means; and
DC blocking means arranged on the input and outputs of the switching means.

19. The portable communication device of claim 18, wherein:
the first filtering means comprises a series inductor.
the second filtering means comprises a series inductor to match the loop element to the first operational frequency band;
the DC blocking means comprise series capacitors; and
a parasitic capacitance parasitically connects the second state of the switching means to ground.

20. The antenna device of claim 18, wherein:
the loop element has an electrical length corresponding to λ for 1850 MHz; and/or
the switching means comprises a SP4T switch having one input and four outputs, one output for each of four states of the switch; and
the antenna device is configured such that:
in the first state of the switching means, frequency band coverage of cellular operational frequency bands 850, 1800, 1900; and 2100 is provided; and
in the second state of the switching means, frequency band coverage of the LTE 700 is provided.
